(19) United States
(12) Patent Application Publication
(10) Pub. No.: US 2024/0333086 A1
(43) Pub. Date: Oct. 3, 2024

(54) ACTUATOR

(71) Applicant: NIDEC INSTRUMENTS CORPORATION, Nagano (JP)

(72) Inventors: Shun SASAKI, Nagano (JP); Akira MORI, Nagano (JP)

(21) Appl. No.: 18/624,118

(22) Filed: Apr. 2, 2024

(30) Foreign Application Priority Data
Apr. 3, 2023 (JP) 2023-059979
Apr. 27, 2023 (JP) 2023-073233

(51) Int. Cl. H02K 5/22; H04R 9/06

(52) U.S. Cl. CPC H02K 5/225; H04R 9/06

(57) ABSTRACT

An actuator includes a support having a tubular case, a movable body having a shaft at a center of the case, a connection member connecting the support with the movable body, and a magnet and a coil structured to relatively move the movable body along the shaft with respect to the support. The connection member includes a ring-shaped inner frame having a through-hole to which the shaft is fitted, a ring-shaped outer frame which is held on an inner side of the case and is disposed on an outer peripheral side with respect to the inner frame, and a connection body which is connected with the outer frame and the inner frame and is provided with at least one of elasticity and viscoelasticity. The inner frame is made of brass, and arithmetic surface roughness of an outer face of the inner frame is not less than 1.0 μm.

### CROSS REFERENCE TO RELATED APPLICATION

The present invention claims priority under 35 U.S.C. § 119 to Japanese Application No. 2023-059979 filed Apr. 3, 2023, and Japanese Application No. 2023-073233 filed Apr. 27, 2023, the entire contents of which are incorporated herein by reference.

### TECHNICAL FIELD

At least an embodiment of the present invention may relate to an actuator in which a movable body is relatively moved with respect to a support body.

### BACKGROUND

As an actuator, a structure has been proposed which includes a connection member connected with a movable body and a support body, and a magnetic drive mechanism structured to move the movable body with respect to the support body. In Japanese Patent Laid-Open No. 2022-083510 (Patent Literature 1), an actuator which uses the connection member is described. In the actuator described in Patent Literature 1, the support body includes a cylindrical case. The movable body includes a magnet and a yoke and a support shaft penetrating through centers of the magnet and the yoke, and both ends in an axial line direction of the support shaft are connected with the case through the connection member in a cylindrical tube shape.

The connection member includes a ring-shaped inner frame part, a ring-shaped outer frame part which is held on an inner side of the case, and a connection body which is connected with the outer frame part and the inner frame part. The connection body is a gel state member provided with at least one of elasticity and viscoelasticity. The inner frame part is fixed to the support shaft which is a part of the movable body. The outer frame part is fixed to the case through a coil holder which is a part of the support body.

The connection body described in Patent Literature 1 is manufactured by a method in which gel material is filled and cured in a mold. When the connection body is to be molded, the outer frame part and the inner frame part are coaxially positioned with each other by a jig to form a ring-shaped space between the outer frame part and the inner frame part, and gel material is filled in this space and thermally cured. As a result, the connection body is joined to an inner peripheral face of the outer frame part and an outer peripheral face of the inner frame part by adhesiveness of the gel state member itself.

The connection member having been manufactured is inspected whether or not the connection body adheres to the inner peripheral face of the outer frame part and the outer peripheral face of the inner frame part. As an inspection method, light is irradiated to the connection body of the connection member, and the connection member is photographed by a camera and a shadow generated in the connection body is observed and a result is determined. In a case that the connection body does not adhere to the inner peripheral face of the outer frame part or the outer peripheral face of the inner frame part, a shadow is observed on an outer peripheral side or an inner peripheral side of the connection body due to that the connection body does not adhere. The connection member in which a shadow is observed is treated as a defective.

Although various materials may be used as the inner frame part, when inspected, depending on the material, there is a case that light reflected by the outer peripheral face of the inner frame part is increased and thereby, the light reflected by the outer peripheral face of the inner frame part is interfered. In this case, even when the connection body adheres to the outer peripheral face of the inner frame part, a shadow may be generated on an inner peripheral side of the connection body due to the interference of the reflected light. As a result, even if the connection member is a non-defective, the connection member may be determined to be a defective. Therefore, there is a problem that inspection of the connection member is unable to be accurately performed depending on material of the inner frame part.

### SUMMARY

In view of the problem described above, at least an embodiment of the present invention may advantageously provide an actuator having an inner frame part which is made of material suitable for inspection of a connection member.

According to at least an embodiment of the present invention, there may be provided an actuator including a support body having a case in a tube shape, a movable body having a support shaft disposed at a center of the case, a connection member which connects the support body with the movable body, and a magnetic drive mechanism which has a magnet and a coil and is structured to relatively move the movable body in an axial line direction of the support shaft with respect to the support body. The connection member includes an inner frame part in a ring shape which is provided with a through-hole to which the support shaft is fitted, an outer frame part in a ring shape which is held on an inner side of the case and is disposed on an outer peripheral side with respect to the inner frame part, and a connection body which is connected with the outer frame part and the inner frame part and is provided with at least one of elasticity and viscoelasticity. The inner frame part is made of brass, and arithmetic surface roughness of an outer peripheral face of the inner frame part is not less than 1.0 μm (micrometre).

According to this embodiment of the present invention, the inner frame part is made of brass capable of being processed at a low cost and thus, a part cost can be reduced. Further, even in a case that brass whose light reflectance is high is used, when the arithmetic surface roughness of an outer peripheral face of the inner frame part is set to be not less than 1.0 μm, unevenness of the outer peripheral face becomes large and reflectance of light reflected by the outer peripheral face is reduced and thus, when the connection member is inspected, light reflected by the outer peripheral face of the inner frame part can be suppressed. As a result, when the connection member is inspected, the connection member can be inspected accurately.

According to at least an embodiment of the present invention, there may be provided an actuator including a support body having a case in a tube shape, a movable body having a support shaft disposed at a center of the case, a connection member which connects the support body with the movable body, and a magnetic drive mechanism which has a magnet and a coil and is structured to relatively move the movable body in an axial line direction of the support shaft with respect to the support body. The connection member includes an inner frame part in a ring shape which is provided with a through-hole to which the support shaft is fitted, an outer frame part in a ring shape which is held on an inner side of the case and is disposed on an outer peripheral side with respect to the inner frame part, and a connection body which is connected with the outer frame part and the inner frame part and is provided with at least one of elasticity and viscoelasticity. The inner frame part is made of stainless steel, and arithmetic surface roughness of an outer peripheral face of the inner frame part is not less than 0.1 μm.

According to this embodiment of the present invention, the inner frame part is made of stainless steel which is inexpensive material and thus, a part cost can be reduced. Further, in a case that stainless steel is used, when arithmetic surface roughness of an outer peripheral face of the inner frame part is set to be not less than 0.1 μm, unevenness of the outer peripheral face becomes large and reflectance of light reflected by the outer peripheral face is reduced and thus, when the connection member is inspected, light reflected by the outer peripheral face of the inner frame part can be suppressed. As a result, when the connection member is inspected, the connection member can be inspected accurately.

According to at least an embodiment of the present invention, there may be provided an actuator including a support body having a case in a tube shape, a movable body having a support shaft disposed at a center of the case, a connection member which connects the support body with the movable body, and a magnetic drive mechanism which has a magnet and a coil and is structured to relatively move the movable body in an axial line direction of the support shaft with respect to the support body. The connection member includes an inner frame part in a ring shape which is provided with a through-hole to which the support shaft is fitted, an outer frame part in a ring shape which is held on an inner side of the case and is disposed on an outer peripheral side with respect to the inner frame part, and a connection body which is connected with the outer frame part and the inner frame part and is provided with at least one of elasticity and viscoelasticity. An outer peripheral portion including at least an outer peripheral face of the inner frame part is made of resin.

According to this embodiment, since the inner frame part is made of resin which is inexpensive material and thus, a part cost can be reduced. Further, when the inner frame part is made of resin, in a case that the connection member is inspected, light reflected by the outer peripheral face of the inner frame part can be suppressed. As a result, when the connection member is inspected, the connection member can be inspected accurately.

In the embodiment described above, it is preferable that the arithmetic surface roughness of the outer peripheral face of the inner frame part is not more than 3.2 μm. According to this structure, the connection body is easily adhered to the outer peripheral face of the inner frame part. In a case that the arithmetic surface roughness of the outer peripheral face of the inner frame part is larger than 3.2 μm, unevenness of the surface becomes large and thus, when the connection body has been molded, a space is easily formed between the outer peripheral face of the inner frame part and the connection body, and the connection body is hard to adhere to the outer peripheral face of the inner frame part.

In the embodiment described above, it is preferable that the inner frame part includes a first member which is the outer peripheral portion, and a second member made of metal which is fitted to an inner side of the first member and is provided with the through-hole, and the support shaft is fixed to the first member through the second member by press-fitting the support shaft to the through-hole. According to this structure, the inner frame part which is provided in the movable body and the outer frame part provided in the support body are connected with each other through the connection body. The inner frame part is structured by assembling two members, i.e., the first member made of resin which is connected with the connection body and the second member made of metal to which the support shaft is press-fitted, which are separately structured. According to this structure, a size of the second member made of metal for securing fixed strength to the support shaft can be reduced and thus, a component cost can be reduced. Further, the second member to which the support shaft is press-fitted is capable of being separated from the first member which is connected with the connection body and thus, handling of parts at the time of press-fitting is easy and the connection body may not be damaged. Therefore, a component cost of the inner frame part can be reduced, fixed strength of the inner frame part to the support shaft is secured, and assembling easiness of the actuator can be enhanced.

In the embodiment described above, it is preferable that the support body is provided with a recessed part to which the outer frame part is fitted, and the recessed part is provided with a step part which is abutted with the outer frame part in the axial line direction of the support shaft when the outer frame part is fitted to the recessed part. According to this structure, the connection member can be positioned with respect to the case in the axial line direction.

### Effects of the Invention

According to the embodiments of the present invention, the inner frame part is made of material suitable for inspection of the connection member and thus, when the connection member is inspected, light reflected by the outer peripheral face of the inner frame part can be suppressed. As a result, when the connection member is inspected, the connection member can be inspected accurately.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an actuator in accordance with a first embodiment of the present invention.

FIG. 2 is an exploded perspective view showing the actuator in FIG. 1.

FIG. 3 is a cross-sectional view showing the actuator in FIG. 1 (“A-A” cross-sectional view in FIG. 1).

FIG. 4 is a cross-sectional view showing the actuator in FIG. 1 (“B-B” cross-sectional view in FIG. 1).

FIG. 5 is an explanatory view showing an inspection apparatus of a connection member.

FIG. 6 is an explanatory view showing an imaging result when a connection member has been imaged in an inspection step.

FIG. 7 is an explanatory view showing a state that a connection member is a defective when an image shown in FIG. 6 has been obtained.

FIG. 8 is a cross-sectional view showing an actuator in accordance with a fourth embodiment of the present invention.

### DETAILED DESCRIPTION

### (Entire Structure)

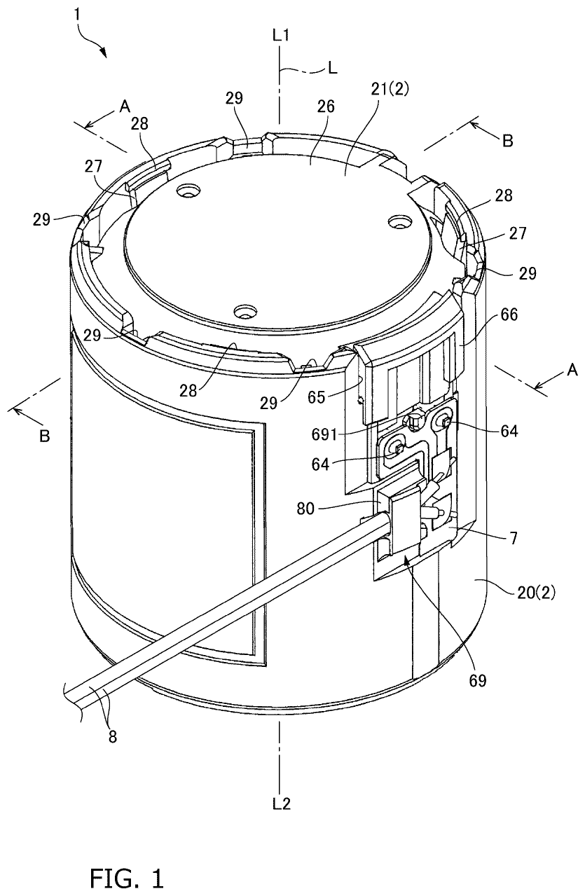

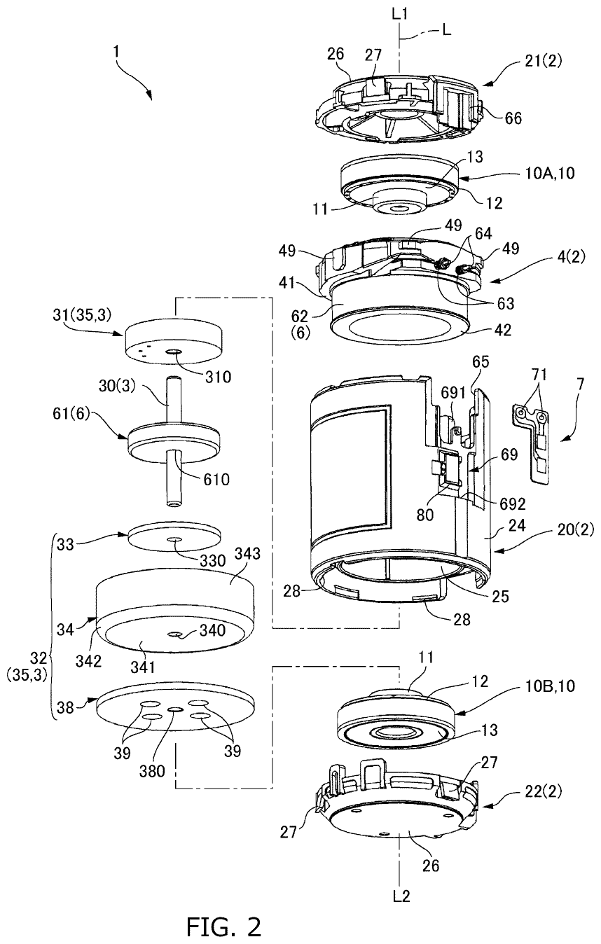

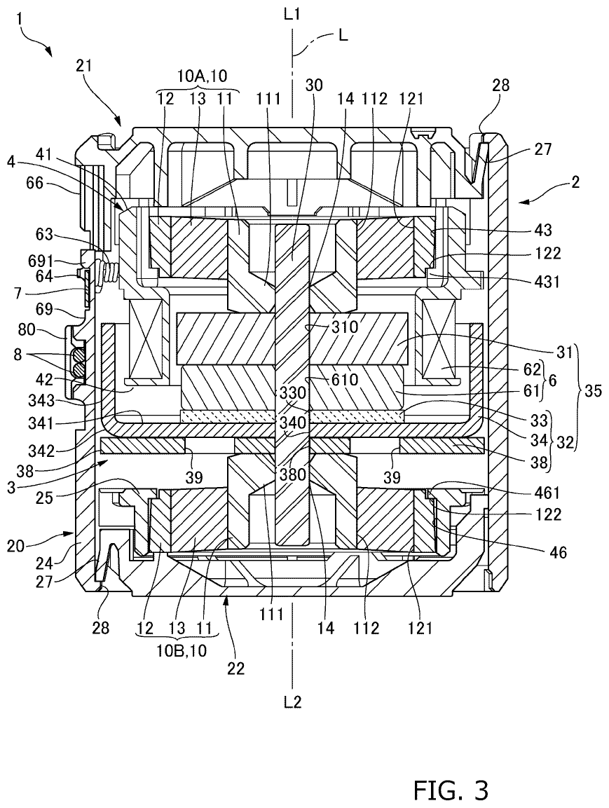

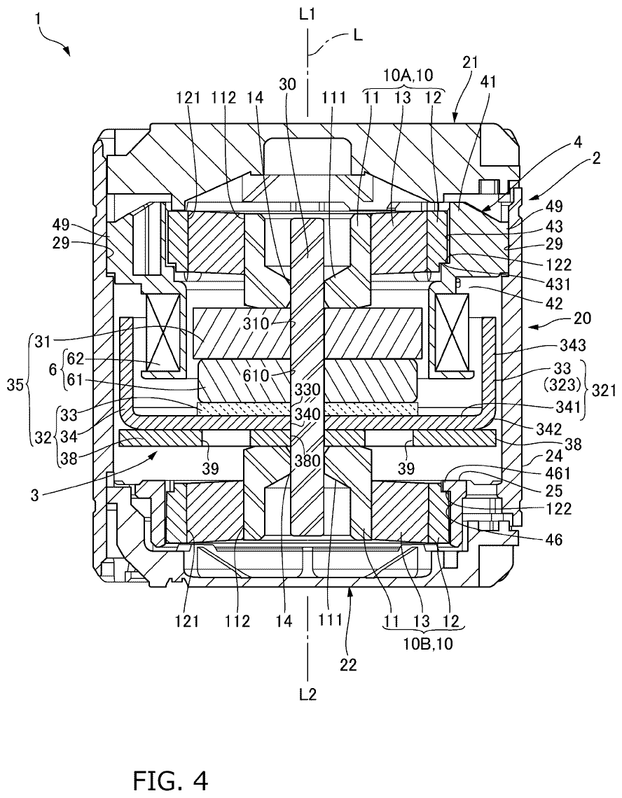

Embodiments of the present invention will be described below with reference to the accompanying drawings. FIG. 1 is a perspective view showing an actuator 1 in accordance with an embodiment of the present invention. FIG. 2 is an exploded perspective view showing the actuator 1 in FIG. 1. FIGS. 3 and 4 are cross-sectional views showing the actuator 1 in FIG. 1. FIG. 3 is a cross-sectional view showing the actuator 1 which is cut at the “A-A” position in FIG. 1. FIG. 4 is a cross-sectional view showing the actuator 1 which is cut at the “B-B” position in FIG. 1 and is cut in a direction perpendicular to the view in FIG. 3. In the following descriptions, a direction in which a center axial line “L” of a movable body 3 is extended is defined as an axial line direction, one side in the axial line direction is referred to as “L1”, and the other side in the axial line direction is referred to as “L2”.

As shown in FIGS. 1 through 4, the actuator 1 includes a support body 2, a movable body 3 having a support shaft 30, a connection body 10 which is connected with the support body 2 and the movable body 3, and a magnetic drive mechanism 6 structured to relatively move the movable body 3 with respect to the support body 2. The connection body 10 is provided with at least one of elasticity and viscoelasticity. The magnetic drive mechanism 6 includes a magnet 61 disposed in the movable body 3 and a coil 62 disposed in the support body 2, and is structured to relatively move the movable body 3 in the axial line direction of the support shaft 30 with respect to the support body 2. As shown in FIGS. 3 and 4, the movable body 3 is connected with the support body 2 through the connection body 10 at respective positions of an end part on one side “L1” in the axial line direction and an end part on the other side “L2” in the axial line direction.

### (Support Body)

As shown in FIGS. 2 through 4, the support body 2 includes a case 20 in a tube shape, a first cover member 21 which closes an opening of the case 20 on one side “L1” in the axial line direction, a second cover member 22 which closes an opening of the case 20 on the other side “L2” in the axial line direction, and a coil holder 4 which is disposed between the first cover member 21 and the second cover member 22 on an inner peripheral side of the case 20. In this embodiment, the case 20, the first cover member 21, the second cover member 22 and the coil holder 4 are made of resin.

### (Case)

The case 20 is provided with a main case body 24 in a cylindrical tube shape and a second fixing part 25 which is disposed on an inner peripheral side of the main case body 24. The second fixing part 25 is disposed at a position separated from the coil holder 4 on the other side “L2” in the axial line direction. As shown in FIGS. 2 and 4, the second fixing part 25 is protruded to an inner peripheral side from an inner peripheral face of the main case body 24 and is integrally molded with the main case body 24. An inner peripheral face of the second fixing part 25 is provided with a second recessed part 46 which is recessed to one side “L1” in the axial line direction. The second recessed part 46 is provided with a step part 461 which is protruded to an inner side in the radial direction.

As shown in FIGS. 1 and 4, an inner peripheral face of the main case body 24 to which the coil holder 4 is fitted is formed with a plurality of groove parts 29 extended in the axial line direction. As shown in FIG. 2, the coil holder 4 is provided with a plurality of protruded parts 49 which are protruded from an outer peripheral face of a first fixing part 41. When the support body 2 is to be assembled, each of the protruded parts 49 of the coil holder 4 is fitted to each of the groove parts 29 of the main case body 24 from one side “L1” in the axial line direction. As a result, the coil holder 4 is press-fitted and fixed to the main case body 24.

### (Coil Holder)

As shown in FIG. 2, the coil holder 4 is provided with the first fixing part 41 in a ring shape, and a body part 42 which is protruded from the first fixing part 41 to the other side “L2” in the axial line direction. A coil 62 is disposed around the body part 42. End parts of a coil wire 63 extended from the coil 62 are bound to two terminal pins 64 which are protruded from the first fixing part 41 of the coil holder 4 to an outer side in a radial direction. As shown in FIG. 1, the terminal pins 64 are protruded outside the case 20 and are connected with a wiring board 7.

As shown in FIG. 4, an inner peripheral face of the first fixing part 41 is provided with a first recessed part 43 which is recessed to the other side “L2” in the axial line direction. The first recessed part 43 is provided with a step part 431 which is protruded to an inner side in the radial direction.

### (Cover Member)

As shown in FIGS. 3 and 4, the first cover member 21 is fixed to the main case body 24 from one side “L1” in the axial line direction with respect to the first fixing part 41 provided in the coil holder 4. Further, the second cover member 22 is fixed to the main case body 24 from the other side “L2” in the axial line direction with respect to the second fixing part 25. As shown in FIG. 2, each of the first cover member 21 and the second cover member 22 is provided with a cover part 26 in a circular shape viewed in the axial line direction and a plurality of engaging parts 27 disposed on an outer peripheral edge of the cover part 26 at equal intervals in a circumferential direction. In this embodiment, each of the first cover member 21 and the second cover member 22 is provided with three engaging parts 27. The engaging part 27 is a claw part which is extended in a direction inclined from the cover part 26 so as to enlarge to an outer peripheral side.

The engaging part 27 is elastically deformed in a radial direction and is pushed into an inner peripheral side of the main case body 24 together with the cover part 26. The case 20 is provided with a restriction part 28 which restricts the engaging part 27 from disengaging from an inner side of the case 20. The restriction part 28 is a protruded part which is protruded to an inner peripheral side from an end part of the main case body 24. As shown in FIGS. 1 and 2, three restriction parts 28 are disposed at equal intervals at each end part on one side “L1” and the other side “L2” in the axial line direction of the main case body 24. The restriction part 28 is abutted with a tip end of the engaging part 27 in the axial line direction. The first cover member 21 and the second cover member 22 are fixed to the case 20 by an engagement structure of the engaging part 27 with the restriction part 28 and, in addition, by using an adhesive. The first fixing part 41 is cut out in portions overlapping in the axial line direction with the three restriction parts 28 provided in the main case body 24. Therefore, when the coil holder 4 is to be inserted into an inside of the main case body 24, an interference of the first fixing part 41 with the restriction part 28 is avoided.

### (Wiring Board)

As shown in FIG. 2, the case 20 is provided with a cut-out part 65 which is formed by cutting out an edge on one side “L1” in the axial line direction to the other side “L2” in the axial line direction, and a board fixing part 69 which is formed on the other side “L2” with respect to the cut-out part 65. As shown in FIG. 1, the wiring board 7 is fixed to the board fixing part 69 by an engagement structure, which is structured of a claw part 691 provided at an end part of the board fixing part 69 on one side “L1” in the axial line direction and an engaging groove 692 provided at an end part of the board fixing part 69 on the other side “L2” in the axial line direction and, in addition, by using an adhesive. The wiring board 7 is connected with lead wires 8 for power feeding to the coil 62. The board fixing part 69 is provided with a lead wire holding part 80 which holds the lead wires 8 at a position adjacent to the wiring board 7 in a circumferential direction.

The first fixing part 41 of the coil holder 4 is disposed on an inner peripheral side of the cut-out part 65. As shown in FIG. 2, coil wires 63 extended from the coil 62 are bound around root portions of two terminal pins 64 which are protruded from the first fixing part 41. The two terminal pins 64 are protruded to an outer peripheral side of the case 20 through a space between a cover 66, which is extended from a part in a circumferential direction of an outer peripheral edge of the first cover member 21 to the other side “L2” in the axial line direction, and the cut-out part 65 of the case 20, and the two terminal pins 64 are passed through two holes 71 provided in the wiring board 7 and are electrically connected with lands provided at edges of the holes 71.

### (Movable Body)

As shown in FIGS. 2, 3 and 4, the movable body 3 includes the support shaft 30 extended in the axial line direction at a center in a radial direction of the support body 2. The magnet 61 and the yoke 35 are fixed to the support shaft 30 by the connection body 10. The support shaft 30 is a round bar made of metal.

The magnet 61 is formed in a circular shape when viewed in the axial line direction. A center in the radial direction of the magnet 61 is provided with a shaft hole 610 through which the support shaft 30 is penetrated, and the magnet 61 is fixed at a substantially center in the axial line direction of the support shaft 30. The yoke 35 includes a first yoke 31 overlapped with the magnet 61 from one side “L1” in the axial line direction and a second yoke 32 which is overlapped with the magnet 61 from the other side “L2” in the axial line direction.

A center of the first yoke 31 is provided with a shaft hole 310 through which the support shaft 30 is penetrated. The first yoke 31 is a magnetic plate whose outside diameter dimension is slightly larger than an outside diameter dimension of the magnet 61, and an outer peripheral face of the first yoke 31 is protruded to an outer side in the radial direction with respect to an outer peripheral face of the magnet 61. The first yoke 31 is fixed to an end face on one side “L1” of the magnet 61 by a method such as adhesion.

The second yoke 32 includes a first magnetic member 33 in a circular plate shape which is abutted with the magnet 61 from the other side “L2” in the axial line direction, a second magnetic member 34 in a cup shape which accommodates the first magnetic member 33, and a third magnetic member 38 in a circular plate shape which is abutted with the second magnetic member 34 from the other side “L2” in the axial line direction. As shown in FIGS. 3 and 4, a plate thickness of the first magnetic member 33, a plate thickness of the second magnetic member 34 and a plate thickness of the third magnetic member 38 are thinner than a plate thickness of the first yoke 31.

The first magnetic member 33 is provided with a shaft hole 330 through which the support shaft 30 is penetrated and is fixed to an end face on the other side “L2” of the magnet 61. The second magnetic member 34 is provided with a circular plate part 341 having a shaft hole 340 through which the support shaft 30 is penetrated, a bent part 342 which is provided at an outer edge of the circular plate part 341, and a cylindrical tube part 343 which is extended to one side “L1” in the axial line direction from the bent part 342. The circular plate part 341 is provided with the shaft hole 340 through which the support shaft 30 is penetrated.

The third magnetic member 38 is provided with a shaft hole 380 through which the support shaft 30 is penetrated and is fixed to the circular plate part 341 of the second magnetic member 34 from the other side “L2” in the axial line direction. The third magnetic member 38 functions as a weight adjustment member which adjusts weight of the movable body 3. The third magnetic member 38 is provided with a weight adjustment part 39. In this embodiment, the weight adjustment part 39 is a circular through-hole. The number and a size of the weight adjustment part 39 is set so that the weight of the third magnetic member 38 is coincided with a designed value without changing an outer shape of the third magnetic member 38. In this embodiment, as shown in FIG. 2, four weight adjustment parts 39 are arranged in a circumferential direction at an angular interval of 90 degrees. Four weight adjustment parts 39 are equally disposed in a circumferential direction with the center of gravity of the movable body 3 as a center.

An outside diameter dimension of the first magnetic member 33 is substantially the same as an outside diameter dimension of the magnet 61, and the first magnetic member 33 is smaller than the circular plate part 341. An inside diameter of the cylindrical tube part 343 of the second magnetic member 34 is larger than outside diameters of the magnet 61 and the first yoke 31. Therefore, when the magnet 61 and the first yoke 31 are overlapped with the first magnetic member 33 from one side “L1” in the axial line direction, the cylindrical tube part 343 faces an outer peripheral face of the magnet 61 and an outer peripheral face of the first yoke 31 at positions separated to an outer side in the radial direction from the outer peripheral face of the magnet 61 and the outer peripheral face of the first yoke 31.

As shown in FIGS. 3 and 4, the body part 42 of the coil holder 4 is inserted to a space in the radial direction between the cylindrical tube part 343 of the second yoke 32 and the first yoke 31 and the magnet 61. Therefore, the coil 62 wound around the body part 42 is disposed between the cylindrical tube part 343 and the outer peripheral face of the magnet 61, and between the cylindrical tube part 343 and the outer peripheral face of the first yoke 31.

### (Connection Body)

The connection member 10 includes a first connection member 10A disposed on one side “L1” in the axial line direction and a second connection member 10B which is disposed on the other side “L2” in the axial line direction. The first connection member 10A and the second connection member 10B have the same shape as each other. Each of the first connection member 10A and the second connection member 10B includes a ring-shaped inner frame part 11 provided with a through-hole 14 to which the support shaft 30 is fitted, a ring-shaped outer frame part 12 which is held on an inner side of the case 20 and is disposed on an outer peripheral side with respect to the inner frame part 11, and a connection body 13 which is connected with the outer frame part 12 and the inner frame part 11. The connection body 13 is a gel state member which is formed by molding gel material.

The inner frame part 11 is made of metal. In this embodiment, the inner frame part 11 is made of brass. The inner frame part 11 is formed in a tube shape and is provided with a ring-shaped outer peripheral face 112. Arithmetic surface roughness “Ra” of the outer peripheral face 112 of the inner frame part 11 is not less than 1.0 μm and not more than 3.2 μm. Material of brass is soft and its processing is easy and thus, the inner frame part 11 can be processed at a low cost. As a result, a part cost of the inner frame part 11 can be reduced.

An inner peripheral face of the inner frame part 11 is formed with a ring-shaped protruded part 111 which is protruded to an inner side in the radial direction. An end part where the ring-shaped protruded part 111 is formed is protruded toward the yoke 35 with respect to the outer frame part 12 in the axial line direction. The ring-shaped protruded part 111 is provided with a through-hole 14 on an inner side in the radial direction. The inner frame part 11 is fixed to the support shaft 30 by press-fitting the through-hole 14 to the support shaft 30. In this embodiment, the magnet 61 and the yoke 35 are held at a center in the axial line direction of the support shaft 30 by respectively fixing the inner frame parts 11 of the first connection member 10A and the second connection member 10B to the support shaft 30.

The outer frame part 12 is made of resin. The outer frame part 12 of the first connection member 10A is fitted to an inner peripheral side of the coil holder 4. More specifically, the outer frame part 12 of the first connection member 10A is press-fitted to the first recessed part 43 of the coil holder 4. In this embodiment, when the outer frame part 12 of the first connection member 10A is fitted to the first recessed part 43, a ring-shaped step part 122 formed in the outer peripheral face of the outer frame part 12 of the first connection member 10A is abutted with the step part 431 in the axial line direction.

The outer frame part 12 of the second connection member 10B is fitted to an inner peripheral side of the case 20. More specifically, the outer frame part 12 of the second connection member 10B is press-fitted to the second recessed part 46. In this embodiment, when the outer frame part 12 of the second connection member 10B is fitted to the second recessed part 46, a ring-shaped step part 122 formed in the outer peripheral face of the outer frame part 12 of the second connection member 10B is abutted with the step part 461 in the axial line direction.

### (Operation of Actuator)

The actuator 1 is operated so that the magnetic drive mechanism 6 generates a drive force for driving the movable body 3 in the axial line direction by supplying an electric current to the coil 62. When the energization to the coil 62 is cut off, the movable body 3 is returned to a home position by a return force of the connection body 13. Therefore, when energization to the coil 62 is intermittently performed, the movable body 3 is vibrated in the axial line direction. Further, when an AC waveform which is applied to the coil 62 is adjusted, an acceleration at which the movable body 3 is moved to one side “L1” in the axial line direction and an acceleration at which the movable body 3 is moved to the other side “L2” in the axial line direction can be made different from each other. As a result, a person who holds an apparatus to which the actuator 1 is attached as a tactile device is capable of bodily sensing vibration having directivity in the axial line direction. Further, a speaker can be structured by utilizing the actuator 1.

In this embodiment, the connection member 10 is disposed at a position where the support body 2 and the movable body 3 face each other in a first direction (radial direction), and the movable body 3 is vibrated in a second direction (axial line direction) intersecting the first direction (radial direction). When the movable body 3 is vibrated in the second direction (axial line direction) with respect to the support body 2, the connection body 13 follows the vibration of the movable body 3 and is deformed in a shearing direction. A gel state member such as silicone gel is provided with linear or nonlinear expansion and contraction characteristics depending on its expansion and contraction direction. When a gel state member is deformed in a shearing direction, the gel state member is provided with deformation characteristics whose linear component is larger than its non-linear component. Therefore, when the movable body 3 is vibrated in the axial line direction with respect to the support body 2, the connection body 13 is deformed in a range where linearity is high and thus, vibration characteristics whose linearity is satisfactory can be obtained.

On the other hand, when the movable body 3 is moved in the radial direction, the connection body 13 is deformed in a crushing direction. In this case, a spring constant when a gel state member is deformed in a crushing direction is about three times of a spring constant when the gel state member is deformed in a shearing direction. Therefore, the movable body 3 can be suppressed from moving in a direction different from a vibration direction (axial line direction) and thus, the movable body 3 and the support body 2 can be prevented from colliding with each other.

### (Manufacturing Method of Connection Member)

The connection body 13 is made of a viscoelastic body. For example, as the connection body 13, the following materials may be used. In other words, a gel state member made of silicone gel or the like, various rubber materials such as natural rubber, diene-based rubber (for example, styrene butadiene rubber, isoprene rubber, butadiene rubber, chloroprene rubber and acrylonitrile butadiene rubber), non-diene-based rubber (for example, butyl rubber, ethylene propylene rubber, ethylene propylene diene rubber, urethane rubber, silicone rubber and fluorine-containing rubber) and thermoplastic elastomer, and their denatured materials may be used. Further, the viscoelastic body which can be used as the connection body 13 may be a composite member made by combining a gel state member, rubber or their denatured materials with an elastic body such as a spring.

In this embodiment, the connection body 13 is made of silicone gel whose penetration degree is from 90 to 110 degrees. The connection body 13 is manufactured by a method in which gel material is filled and cured in a mold. When the connection body 13 is to be molded, the outer frame part 12 and the inner frame part 11 are coaxially positioned by a jig to form a ring-shaped space between the outer frame part 12 and the inner frame part 11, and gel material is filled and thermally cured in the space. As a result, the connection body 13 is joined to an inner peripheral face 121 of the outer frame part 12 and an outer peripheral face 112 of the inner frame part 11 by adhesiveness of the gel state member itself.

In this case, joining strength can be increased by applying a joining accelerating agent such as primer on the inner peripheral face 121 of the outer frame part 12 and the outer peripheral face 112 of the inner frame part 11 before gel material is filled.

### (Inspection Method of Connection Member)

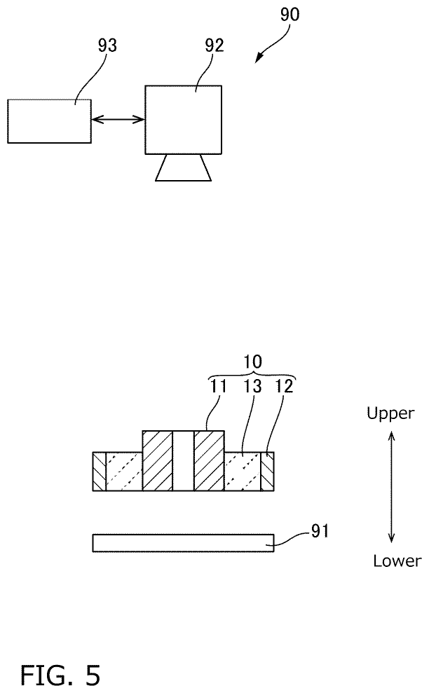

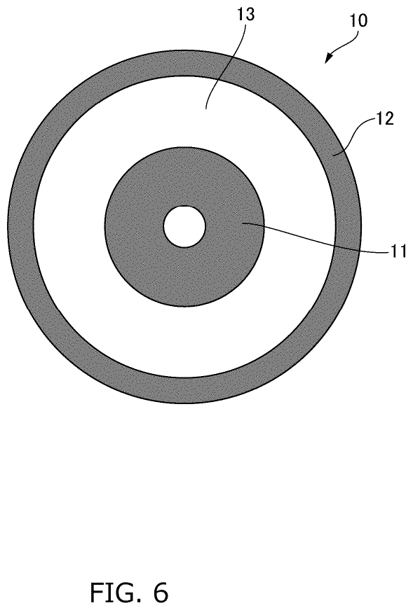

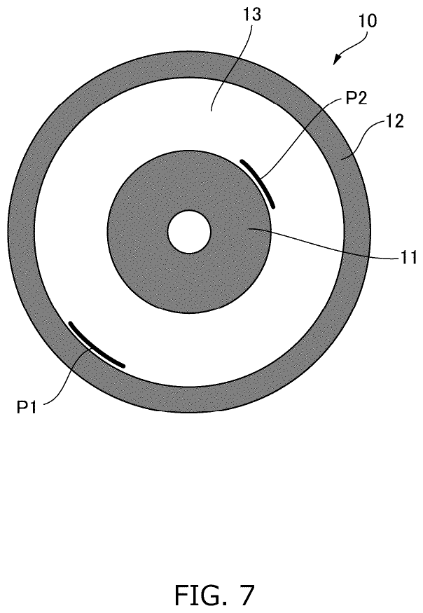

Next, an inspection method of the connection member 10 will be described below. FIG. 5 is an explanatory view showing an inspection apparatus of the connection member 10. FIG. 6 is an explanatory view showing an imaging result when the connection member 10 is imaged in an inspection step. FIG. 7 is an explanatory view showing a state that the connection member 10 is a defective when an image shown in FIG. 6 has been obtained.

As shown in FIG. 5, in a step for inspecting the connection member 10, an inspection apparatus 90 is used which includes a light source 91 for irradiating light on the connection member 10, a camera 92 for imaging the connection member 10 irradiated with light, and a determination part 93 which determines whether the connection member 10 is good or not. The light source 91 irradiates light toward the connection member 10 from a lower side. The camera 92 images the connection body 13 irradiated with light from an upper side of the connection member 10. In this case, it may be structured that the light source 91 irradiates light toward the connection member 10 from an upper side of the connection member 10.

The determination part 93 determines whether the connection member 10 is good or not on the basis of a captured image. In this embodiment, the connection body 13 has a light-transmitting property and thus, when malfunction occurs in the connection member 10, a shadow is observed in the image in a portion of the connection body 13. Specifically, as shown in FIG. 6, in a case that the connection body 13 adheres to the inner peripheral face 121 of the outer frame part 12 and the outer peripheral face 112 of the inner frame part 11, a shadow due to that the connection body 13 does not adhere is not observed in an outer peripheral portion and an inner peripheral portion of the connection body 13.

On the other hand, as shown in FIG. 7, in a case that the connection body 13 does not adhere to the inner peripheral face 121 of the outer frame part 12, a shadow “P1” in a circular arc shape due to that the connection body 13 does not adhere is observed on an outer peripheral side of the connection body 13. Further, in a case that the connection body 13 does not adhere to the outer peripheral face 112 of the inner frame part 11, a shadow “P2” in a circular arc shape due to that the connection body 13 does not adhere is observed in an inner peripheral side of the connection body 13. An air layer exists in a portion where the connection body 13 does not adhere and thus, the air layer is observed as the shadows “P1” and “P2”.

In this embodiment, in a case that the inner frame part 11 is made of brass, and the arithmetic surface roughness “Ra” of the outer peripheral face 112 of the inner frame part 11 is smaller than 1.0 μm, unevenness of the outer peripheral face 112 becomes small and reflectance of the light reflected by the outer peripheral face 112 becomes large. As a result, when the connection member 10 is inspected, light reflected by the outer peripheral face 112 is increased and thus, the light reflected by the outer peripheral face 112 may interfere. In this case, even when the connection body 13 adheres to the outer peripheral face 112 of the inner frame part 11, a shadow “P2” may be generated on an inner peripheral side of the connection body 13 due to interference of the reflected light. As a result, there is a possibility that the determination part 93 determines that the connection member 10 is a defective even if the connection member 10 is a non-defective. On the other hand, according to this embodiment, the arithmetic surface roughness “Ra” of the outer peripheral face 112 of the inner frame part 11 is not less than 1.0 μm and thus, unevenness of the outer peripheral face 112 becomes large and reflectance of light reflected by the outer peripheral face 112 is reduced. As a result, light reflected by the outer peripheral face 112 is reduced and thus, interference of the light reflected by the outer peripheral face 112 is suppressed. Therefore, when the connection body 13 adheres to the outer peripheral face 112 of the inner frame part 11, the shadow “P2” can be suppressed from erroneously generating. In this embodiment, the outer frame part 12 is made of resin and thus, reflectance of light reflected by the inner peripheral face 121 is small and, therefore, interference of the light reflected by the inner peripheral face 121 is suppressed.

### Operations and Effects

According to this embodiment, the inner frame part 11 can be processed at a low cost and thus, a part cost can be reduced. Further, even in a case that brass whose light reflectance is high is used, when the arithmetic surface roughness “Ra” of the outer peripheral face 112 of the inner frame part 11 is set to be not less than 1.0 μm, unevenness of the outer peripheral face 112 becomes large and reflectance of light reflected by the outer peripheral face 112 is reduced and thus, when the connection member 10 is inspected, light reflected by the outer peripheral face 112 of the inner frame part 11 can be suppressed. As a result, when the connection member 10 is inspected, inspection of the connection member can be performed accurately.

In this embodiment, the arithmetic surface roughness of the outer peripheral face 112 of the inner frame part 11 is not more than 3.2 μm. According to this structure, the connection body 13 is easily adhered to the outer peripheral face 112 of the inner frame part 11. In a case that the arithmetic surface roughness “Ra” of the outer peripheral face 112 of the inner frame part 11 is larger than 3.2 μm, unevenness of the face becomes large and thus, when the connection body 13 has been molded, a space is easily formed between the outer peripheral face 112 of the inner frame part 11 and the connection body 13, and the connection body 13 is hard to adhere to the outer peripheral face 112 of the inner frame part 11.

In this embodiment, the support body 2 is provided with the first recessed part 43 and the second recessed part 46 to which the outer frame parts 12 are fitted. The first recessed part 43 is provided with the step part 431 which is abutted with the outer frame part 12 in the axial line direction when the outer frame part 12 is fitted to the first recessed part 43. Further, the second recessed part 46 is provided with the step part 461 which is abutted with the outer frame part 12 in the axial line direction when the outer frame part 12 is fitted to the second recessed part 46. As a result, the connection member 10 can be positioned in the case 20 in the axial line direction.

### Second Embodiment

The inner frame part 11 may be made of stainless steel. In this case, the arithmetic surface roughness “Ra” of the outer peripheral face 112 of the inner frame part 11 is set to be not less than 0.1 μm and not more than 3.2 μm. In this embodiment, in a case that the arithmetic surface roughness “Ra” of the outer peripheral face 112 of the inner frame part 11 is smaller than 0.1 μm, unevenness of the outer peripheral face 112 becomes small and reflectance of the light reflected by the outer peripheral face 112 becomes large. Further, in a case that the arithmetic surface roughness “Ra” of the outer peripheral face 112 of the inner frame part 11 is larger than 3.2 μm, unevenness of the face becomes large and thus, when the connection body 13 has been molded, a space is easily formed between the outer peripheral face 112 of the inner frame part 11 and the connection body 13, and the connection body 13 is hard to adhere to the outer peripheral face 112 of the inner frame part 11. Therefore, in the second embodiment, the arithmetic surface roughness “Ra” of the outer peripheral face 112 of the inner frame part 11 is set to be not less than 0.1 μm and, in addition, not more than 3.2 μm and thus, operations and effects similar to the first embodiment can be obtained. Further, since the inner frame part 11 is made of stainless steel which is inexpensive material, a part cost can be reduced. Reflectance of light of the stainless steel is lower than that of brass and thus, the arithmetic surface roughness “Ra” of the outer peripheral face 112 of the inner frame part 11 can be reduced to 0.1 μm.

### Third Embodiment

The inner frame part 11 may be made of resin. In this case, reflectance of light reflected by the outer peripheral face 112 is small and thus, when the connection member 10 is inspected, light reflected by the outer peripheral face 112 of the inner frame part 11 can be suppressed. As a result, when the connection member 10 is inspected, inspection of the connection member can be performed accurately. Further, since the inner frame part 11 is made of resin which is inexpensive material, a part cost can be reduced. In this embodiment, it is preferable that resin which is used as the inner frame part 11 is resin which has no light-transmitting property.

### Fourth Embodiment

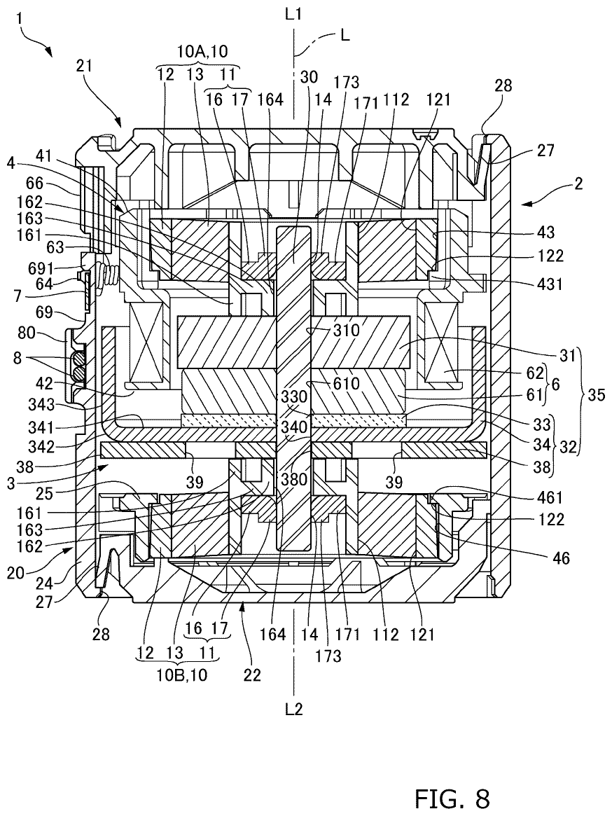

An actuator in a fourth embodiment is similar to the actuator in the first embodiment except the structure of the connection member 10. Therefore, in the fourth embodiment, the same reference numerals are used in the structures similar to the first embodiment and their explanations may be omitted. FIG. 8 is a cross-sectional view showing an actuator 1 in accordance with a fourth embodiment of the present invention.

The connection member 10 includes a ring-shaped inner frame part 11 provided with a through-hole 14 to which a support shaft 30 is fitted, a ring-shaped outer frame part 12 which is held on an inner side with respect to the case 20 and is disposed on an outer peripheral side with respect to the inner frame part 11, and a connection body 13 which is connected with the outer frame part 12 and the inner frame part 11. The outer frame part 12 is made of resin. The connection body 13 is a gel state member which is formed by molding gel material.

The inner frame part 11 includes a first member 16 which is its outer peripheral portion and a second member 17 disposed on an inner side of the first member 16. The first member 16 is made of resin. The second member 17 is made of metal. In this embodiment, it is preferable that the resin which is used as the first member 16 is resin which has no light-transmitting property.

The second member 17 is, for example, made of SECC (electrogalvanized steel sheet). In this embodiment, the second member 17 may be formed of metal different from SECC. As shown in FIG. 8, the second member 17 is provided with a circular plate part 171 and a protruded part 173 which rises in the axial line direction from an edge of a through-hole 14 penetrating through a center of the plate part 171. The second member 17 is a pressed product, and the protruded part 173 is formed by burring processing. As a result, since the second member 17 is a pressed product, a manufacturing cost can be reduced. Further, a press-fitting margin when the support shaft 30 is press-fitted and fixed can be secured by providing the protruded part 173. Therefore, fixed strength of the support shaft 30 to the second member 17 can be secured.

The first member 16 is provided with an outer side tube part 161, an inner side tube part 162 disposed on an inner peripheral side with respect to the outer side tube part 161, and a connection part 163 which connects the outer side tube part 161 with the inner side tube part 162. The outer side tube part 161 and the inner side tube part 162 are formed in a cylindrical tube shape and are coaxially disposed each other. A length in the axial line direction of the inner side tube part 162 is shorter than that of the outer side tube part 161, and the inner side tube part 162 is disposed at an end part of the outer side tube part 161 on one side “L1” or the other side “L2” in the axial line direction. The second member 17 is fitted to an inner side of the outer side tube part 161 from an outer side in the axial line direction.

The inner side tube part 162 is disposed at an end part in the axial line direction of the outer side tube part 161. The connection part 163 is disposed at a substantially center in the axial line direction of the outer side tube part 161 and is connected with an end part in the axial line direction of the inner side tube part 162.

An outer peripheral face 112 of the inner frame part 11 is joined to the connection body 13. In this embodiment, the outer peripheral face 112 of the inner frame part 11 is an outer peripheral face of the outer side tube part 161 of the first member 16.

When the inner frame part 11 is to be attached to an end part of the support shaft 30, the end part of the support shaft 30 is passed through a shaft hole 164 provided at a center of the first member 16 in a state that the first member 16 and the second member 17 are separated from each other. In this embodiment, when the connection body 13 is to be manufactured, the connection body 13 is joined to the inner peripheral face 121 of the outer frame part 12 and to the outer peripheral face 112 of the first member 16. Therefore, an operation is performed in which the end part of the support shaft 30 is passed through the shaft hole 164 of the first member 16 in a state that the connection body 13 has been joined to the outer peripheral face of the outer side tube part 161. The shaft hole 164 of the first member 16 is a through hole penetrating through the inner side tube part 162. An inside diameter of the shaft hole 164 is set to be a dimension for fitting the support shaft 30 in a transition-fitted state.

Next, the second member 17 is fitted to an inner side of the outer side tube part 161 of the first member 16, and the end part of the support shaft 30 is press-fitted into the through-hole 14 of the second member 17 and the plate part 171 of the second member 17 is abutted with the connection part 163 of the first member 16. As a result, the support shaft 30 is fixed to the first member 16 through the second member 17.

### Operations and Effects

According to this embodiment, since the first member 16 is made of resin, light reflected by the outer peripheral face 112 of the inner frame part 11 can be suppressed when the connection member 10 is inspected. As a result, in the fourth embodiment, operations and effects similar to the third embodiment can be obtained.

Further, according to the fourth embodiment, the inner frame part 11 provided in the movable body 3 are structured by assembling two members, i.e., the first member 16 connected with the connection body 13 and the second member 17 to which the support shaft 30 is press-fitted, which are separately provided from each other. Therefore, a size of the second member 17 made of metal for securing fixed strength to the support shaft 30 can be reduced and thus, in comparison with a case that the entire inner frame part 11 is made of metal, a component cost is reduced. Further, the second member 17 to which the support shaft 30 is press-fitted and fixed is capable of being separated from the first member 16 connected with the connection body 13 which is a gel state member. Therefore, in the press-fitting step, the second member 17 to which a gel state member is not joined is held by a jig and the press-fitting step is performed and thus, handling of parts is easy and the gel state member (connection body 13) may not be damaged. Accordingly, a component cost of the inner frame part 11 can be reduced, fixed strength of the inner frame part 11 to the support shaft 30 is secured, and assembling easiness of the actuator 1 can be enhanced.

Further, the support shaft 30 is fitted to the shaft hole 164 in a transition fitting state. As a result, since the support shaft 30 and the first member 16 can be easily assembled, even in a state that a gel state member has been joined to the first member 16, the gel state member may not be damaged.

Embodiments of the present invention may be structured as follows.
(1) An actuator including a support body having a case in a tube shape, a movable body having a support shaft disposed at a center of the case, a connection member which connects the support body with the movable body, and a magnetic drive mechanism which has a magnet and a coil and is structured to relatively move the movable body in an axial line direction of the support shaft with respect to the support body. The connection member includes a ring-shaped inner frame part provided with a through-hole to which the support shaft is fitted, a ring-shaped outer frame part which is held on an inner side of the case and is disposed on an outer peripheral side with respect to the inner frame part, and a connection body which is connected with the outer frame part and the inner frame part and is provided with at least one of elasticity and viscoelasticity, the inner frame part is made of brass, and arithmetic surface roughness of an outer peripheral face of the inner frame part is not less than 1.0 μm.
(2) An actuator including a support body having a case in a tube shape, a movable body having a support shaft disposed at a center of the case, a connection member which connects the support body with the movable body, and a magnetic drive mechanism which has a magnet and a coil and is structured to relatively move the movable body in an axial line direction of the support shaft with respect to the support body. The connection member includes a ring-shaped inner frame part provided with a through-hole to which the support shaft is fitted, a ring-shaped outer frame part which is held on an inner side of the case and is disposed on an outer peripheral side with respect to the inner frame part, and a connection body which is connected with the outer frame part and the inner frame part and is provided with at least one of elasticity and viscoelasticity, the inner frame part is made of stainless steel, and arithmetic surface roughness of an outer peripheral face of the inner frame part is not less than 0.1 μm.
(3) An actuator including a support body having a case in a tube shape, a movable body having a support shaft disposed at a center of the case, a connection member which connects the support body with the movable body, and a magnetic drive mechanism which has a magnet and a coil and is structured to relatively move the movable body in an axial line direction of the support shaft with respect to the support body. The connection member includes a ring-shaped inner frame part provided with a through-hole to which the support shaft is fitted, a ring-shaped outer frame part which is held on an inner side of the case and is disposed on an outer peripheral side with respect to the inner frame part, and a connection body which is connected with the outer frame part and the inner frame part and is provided with at least one of elasticity and viscoelasticity, and an outer peripheral portion including at least an outer peripheral face of the inner frame part is made of resin.
(4) The actuator described in the above-mentioned structured (1) or (2), where the arithmetic surface roughness of the outer peripheral face of the inner frame part is not more than 3.2 μm.
(5) The actuator described in the above-mentioned structure (3), where the inner frame part includes a first member which is the outer peripheral portion and a second member made of metal which is fitted to an inner side of the first member and is provided with the through-hole, and the support shaft is fixed to the first member through the second member by press-fitting the support shaft to the through-hole.
(6) The actuator described in one of the above-mentioned structures (1) through (5), where the support body is provided with a recessed part to which the outer frame part is fitted, and the recessed part is provided with a step part which is abutted with the outer frame part in the axial line direction of the support shaft when the outer frame part is fitted to the recessed part.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An actuator comprising:
a support body comprising a case in a tube shape;
a movable body comprising a support shaft disposed at a center of the case;
a connection member which connects the support body with the movable body; and
a magnetic drive mechanism which comprises a magnet and a coil and is structured to relatively move the movable body in an axial line direction of the support shaft with respect to the support body;
wherein the connection member comprises:
an inner frame part in a ring shape which comprises a through-hole to which the support shaft is fitted;
an outer frame part in a ring shape which is held on an inner side of the case and is disposed on an outer peripheral side with respect to the inner frame part; and
a connection body which is connected with the outer frame part and the inner frame part and is provided with at least one of elasticity and viscoelasticity, the inner frame part is made of brass; and
arithmetic surface roughness of an outer peripheral face of the inner frame part is not less than 1.0 μm (micrometre).

2. An actuator comprising:
a support body comprising a case in a tube shape;
a movable body comprising a support shaft disposed at a center of the case;
a connection member which connects the support body with the movable body; and
a magnetic drive mechanism which comprises a magnet and a coil and is structured to relatively move the movable body in an axial line direction of the support shaft with respect to the support body;
wherein the connection member comprises:
an inner frame part in a ring shape which comprises a through-hole to which the support shaft is fitted;
an outer frame part in a ring shape which is held on an inner side of the case and is disposed on an outer peripheral side with respect to the inner frame part; and
a connection body which is connected with the outer frame part and the inner frame part and is provided with at least one of elasticity and viscoelasticity;
the inner frame part is made of stainless steel; and
arithmetic surface roughness of an outer peripheral face of the inner frame part is not less than 0.1 μm (micrometre).

3. An actuator comprising:
a support body comprising a case in a tube shape;
a movable body comprising a support shaft disposed at a center of the case;
a connection member which connects the support body with the movable body; and
a magnetic drive mechanism which comprises a magnet and a coil and is structured to relatively move the movable body in an axial line direction of the support shaft with respect to the support body;
wherein the connection member comprises:
an inner frame part in a ring shape which comprises a through-hole to which the support shaft is fitted;
an outer frame part in a ring shape which is held on an inner side of the case and is disposed on an outer peripheral side with respect to the inner frame part; and
a connection body which is connected with the outer frame part and the inner frame part and is provided with at least one of elasticity and viscoelasticity; and
an outer peripheral portion including at least an outer peripheral face of the inner frame part is made of resin.

4. The actuator according to claim 1, wherein the arithmetic surface roughness of the outer peripheral face of the inner frame part is not more than 3.2 μm.

5. The actuator according to claim 3, wherein
the inner frame part comprises a first member which is the outer peripheral portion and a second member made of metal which is fitted to an inner side of the first member and comprises the through-hole, and
the support shaft is fixed to the first member through the second member by press-fitting the support shaft to the through-hole.

6. The actuator according to claim 1, wherein
the support body comprises a recessed part to which the outer frame part is fitted, and
the recessed part comprises a step part which is abutted with the outer frame part in the axial line direction of the support shaft when the outer frame part is fitted to the recessed part.

7. The actuator according to claim 2, wherein the arithmetic surface roughness of the outer peripheral face of the inner frame part is not more than 3.2 μm.

8. The actuator according to claim 2, wherein
the support body comprises a recessed part to which the outer frame part is fitted, and
the recessed part comprises a step part which is abutted with the outer frame part in the axial line direction of the support shaft when the outer frame part is fitted to the recessed part.

9. The actuator according to claim 3, wherein
the support body comprises a recessed part to which the outer frame part is fitted, and
the recessed part comprises a step part which is abutted with the outer frame part in the axial line direction of the support shaft when the outer frame part is fitted to the recessed part.
